(19) United States
(12) Patent Application Publication
(10) Pub. No.: US 2019/0031332 A1
(43) Pub. Date: Jan. 31, 2019

(54) A ROTOR SYSTEM AND AN AIR VEHICLE EQUIPPED WITH SUCH ROTOR

(71) Applicant: GAZIANTEP ÜNIVERSITESI REKTÖRLÜGÜ, Sehitamil Gaziantep (TR)

(72) Inventors: Mehmet Hanifi Dogru, Gaziantep (TR); Ibrahim Halil Guzelbey, Gaziantep (TR); Ibrahim Gov, Gaziantep (TR)

(21) Appl. No.: 16/077,125

(22) PCT Filed: Feb. 10, 2017
(86) PCT No.: PCT/TR2017/050058

§ 371 Date: Aug. 10, 2018

(30) Foreign Application Priority Data
Feb. 10, 2016 (TR) 2016/01741

(51) Int. Cl. B64C 27/72; B64C 27/14

(52) U.S. Cl. CPC B64C 27/72; B64C 2027/7294; B64C 27/14

(57) ABSTRACT

A rotor system comprising hinged stabilizing flaps (6) which compensate for the torque generated by a main rotor of an air vehicle and provide the air vehicle with the rotation around its own axis, the rotor system further comprising deflecting flaps (12) which allow the air vehicle to move forward, backward, right and left.

### SUBJECT OF THE INVENTION

Invention is about a rotor system which enables the conventional helicopters to offer safer and more stable flights without the need for tail and tail rotor (anti-torque rotor) and features compensating elements for the torque created by the propeller, and a new air vehicle embodying such a rotor system.

### BACKGROUND OF THE INVENTION AND THE STATE OF THE ART

The present invention relates to a rotor for air vehicles.

Conventional helicopters consist of a main fuselage comprising passenger or cargo cabin, a tail boom, a main rotor component on the main fuselage and a tail rotor, a.k.a. anti-torque rotor, located on the tail boom in order to compensate for the torque generated by the main rotor.

The existing state of the art reveals that, in the conventional helicopter systems equipped with tail rotor, a tail rotor is used to compensate for the torque effect generated by the main rotor of the helicopter and enable helicopter to turn around its axis, in other words, to maneuver as much as required.

The distance of the tail rotor from the main rotor is inversely proportional to the power of the tail propeller. The longer the length of the tail, the less power is required. This is because the compensation of the torque generated by the main rotor is achieved by the tail rotor on the basis of a logical equation that torque is force times lever arm.

Various improvements have been introduced to the tail rotor in order to increase the flight stability of the helicopters. However, despite the innovations introduced to the main rotor system, the problems originating from the tail system itself have remained unsolved. The tail systems integrated to the conventional helicopters pose hazard for the flight crews and flight environment during landing, departure and voyage inside a windy weather due to the long tail boom.

In order to eliminate this problem, air vehicles not having tail rotor but rotor, have been developed, which operates in accordance with the working principles of a helicopter. These improved systems are called flying platforms. However, in these developments, the steering and maneuvering of the air vehicles (flying platforms) is achieved through the pilot's body movements. In addition, two propellers positioned one over the other and rotating in the opposite direction are used in these systems.

An unbiased technical problem intended to be solved is the achievement of an air vehicle equipped with the components of a mechanism that requires no tail boom and offers turns and maneuvers without the need for controlling them with the body movements of a pilot. Technical effect to be obtained from the solution of this problem will be to improve the flight safety and stability of the air vehicle. Attempts, in this regard, have been made to develop a system to replace tail boom and tail rotor system used to provide the stability of a helicopter and maneuverability around its axis in the existing technique.

### DESCRIPTION OF THE INVENTION

The objective of the invention is to eliminate the tail and the tail mechanism problems experienced in the existing helicopters. The subject helicopter of the invention has no tail system unlike conventional helicopters which are made up of body and tail.

In the developed system, a single rotor system is employed instead of the eliminated tail boom and the tail rotor mechanism. Overall weight of the air vehicle is reduced by this means. The system which is the subject of the invention will be able to achieve safer and more stable flights since the tail group is removed. Air vehicles comprising the rotor system of the invention can be employed for many different purposes such as security, unmanned air vehicle, transportation and health.

The basic heuristic concept in the new rotor system is based on the principle to eliminate the tail system available in the conventional helicopters and accordingly the anti-torque rotor system integrated to the tail boom.

Instead of them, in the new rotor system structure there are hinged stabilizing flaps (6) the details of which are shown in the FIG. 1 and FIG. 8 in order for the helicopter to compensate for the torque generated by the main rotor and make maneuvers around its own axis. There are deflecting flaps (12) the details of which are shown in the FIG. 1 and FIG. 14 in order to provide the helicopter with an ability to move forward, backward, right and left. Details of these hinged stabilizing flaps (6) and deflecting flaps (12) which are of critical importance for the new rotor system are described below.

The invention, at its most basic form, is a rotor system for a rotor air vehicle comprising an outer frame which constitutes the main body of the rotor system in a suitable structure to accommodate moving and fixed components and allow the rotation of a propeller (4) in its inner zone, and offers at least two mutual openings through which the air will enter the system and leave the system, and characterized by a propeller (4) which is located inside the aforementioned outer frame and centrally connected to the ceiling of the outer frame in such a way that its front face will be pointing at the inner zone and function as the main rotor, and a motor to generate the required torque to run the said propeller (4), the hinged stabilizing flaps (6) which are positioned against the front face of the said propeller (4) and have planar plates extending in the radial direction towards the outer frame from a central hub (8) facing the propeller (4) center and fully or nearly perpendicular to the centerline of the propeller (4) and meet the torque requirements by which the said plates move around the axes parallel to the rotation plane of the propeller (4) by adjusting their angles with respect to the rotation plane, a motor to actuate the hinged stabilizing flaps (6), and deflecting flaps (12) which are located at the other side of the hinged stabilizing flaps (6), have and are constituted from the planar plates fully or nearly perpendicular to the centerline of the propeller (4) and allow the air vehicle to move forward, backward, right and left by rotating the aforementioned plates in the desired direction by means of motors.

The aforementioned outer frame comprises of the end rings (1) which are circular or considerably circular and form a cylindrical inner zone on a large scale by positioning them fully or nearly parallel to each other in such a way that their centers are lined up on the same vertical axis and the side support rods (5) which are suitable to fix the positions of the end rings (1) with respect to each other, line up around the end ring (1) perimeter extending from one circle arc to another, connects the end rings (1) with each other and also forms a surface to install the components located inside the system.

A preferred embodiment working in accordance with the principles of the invention is as follows:

Two end rings (1) located at the top and bottom, which are positioned completely or considerably parallel to each other are used in the invention in order to form the main body of the rotor system. Form of the end rings (1) are completely or considerably circular. The aforementioned end rings (1) may preferably be made of aluminum composite material. An upper mount brace (2), as shown in the FIG. 1, is used in such a way that it passes through the center of one of the aforementioned end rings (1) located at the top and extends along with its diameter. The upper mount brace (2) may preferably be made of aluminum. The center of the end ring (1) overlaps the center of the upper mount brace (2). An electric motor (3), preferably a brushless electric motor (3) is placed centrally onto the bottom surface of the aforementioned upper mount brace (2). The said electric motor (3) supplies the input torque necessary for the operation of the propeller (4) which provides the lifting force for the air vehicle. The said propeller (4) is integrated to the electric motor (3) located at the center of the ring and the upper mount brace (2). Propeller (4) has two blades for the preferred embodiment. There may be more blades for the different embodiments.

The aforementioned upper and lower end rings (1) positioned parallel to each other are concentric. There are side support rods (5) which fix the end ring (1) located at the bottom to the end ring (1) located at the top and extends from one circle arc to the other's circle arc. The side support rods (5) may preferably be made of aluminum. Quantity of the side support rods (5) may be two, three, four, five, six, seven, eight or more. In the preferred embodiment there are eight side support rods (5).

There are four hinged stabilizing flaps (6) positioned to meet the front face of the propeller (4) in order to provide stability and rotation of the helicopter on its own axis. These hinged stabilizing flaps (6) extend from a central hub (8) corresponding to the propeller (4) center towards the side support rods (5) which connect the rings. The hinged stabilizing flaps (6) extend on the hinged stabilizing flap rods (7) which are connected to the side support rods (5) by extending from the central hub (8). The hinged stabilizing flaps (6) are in the form of a planar quadrangle as demonstrated in the FIG. 8. They are preferably rectangular in shape and the hinged stabilizing flap rods (7) extend from one short edge to the other short edge. These hinged stabilizing flap rods (7) extending from one short edge to the other short edge are terminated by connecting them to the central hub (8) from one end and to the side support rods (5) from the other end. The hinged stabilizing flap rods (7) are made of carbon in the preferred embodiment.

The working principle of the hinged stabilizing flap (6) is as follows:

The air blown downward by the propeller (4) strikes the hinged stabilizing flaps (6) and compensates for the anti-torque generated by the rotation of the propeller (4). Additionally, rotation of the helicopter around its own axis is provided by positioning (rotating around its own axis) the hinged stabilizing flaps (6) which will increase/decrease the effect of the air flowing downward in a vectorial manner by means of a servo motor (11) integrated to the center of the system.

In one embodiment, there are hinged stabilizing flap holders (15) which are located at the edges of the hinged stabilizing flaps (6) close to the center and/or to the side support rods (5) and wrapping and holding these edges completely or, at least, partially. The hinged stabilizing flap holders (15) are shown in the FIG. 17 in details. Their locations are demonstrated in the FIG. 1 and FIG. 26 as well. In some embodiments, they are also located in the middle of the hinged stabilizing flaps (6).

In one embodiment, there are a total of twelve hinged stabilizing flap holders (15), where each hinged stabilizing flap (6) has three of them, in order to fix the hinged stabilizing flaps (6) to the hinged stabilizing flap rods (7).

A servo motor (11) and a bevel gear (22), which enable positioning by actuating the hinged stabilizing flaps (6) are provided in the central hub (8). The hinged stabilizing flap rods (7) are connected to the bevel gears (22) in the central hub (8). The movement is transmitted from the servo motor (11) to the bevel gears (22), from the bevel gears (22) to the hinged stabilizing flap rods (7) and, in this way, to the hinged stabilizing flaps (6). The central hub (8) is used to secure the servo motor (11) and bevel gear (22) involved in positioning.

These systems are transferred to the servo motors (11) with the help of cables brought outside the system by means of the upper mount brace (2).

Central hub cap (17) with four holes provided on it is used to ensure that the hinged stabilizing flap rods (7) are fully seated on the bevel gear (22) and are fastened to the central hub (8). Central hub cap (17) is preferably manufactured from a plastic material with a three-dimensional printer.

The central hub (8) is a component manufactured from a plastic material using a three-dimensional printer in the preferred embodiment. It is the radial struts (9) which center the central hub (8) and keep it fixed in such a way as to be positioned on the central axes of the end rings (1). The radial struts (9) connect the central hub (8) to the side support rods (5). In more detail, the radial struts (9) extend from the central hub (8) to the side support rods (5) and fasten to the side support rods (5) by means of the radial strut clamping couplers (10). Number of the radial struts (9) are two, where mutually located, or more for stable positioning. There are four in the preferred embodiment. The radial struts (9) are positioned at the lower part of the central hub (8). They rare located at the bottom of the hinged stabilizing flaps (6).

Radial strut clamping couplers (10) which fix the radial struts (9) to the side support rods (5) are a fixing component in a form the inside of which is drilled and slotted as shown in the FIG. 12. It is preferably manufactured from a plastic material with a three-dimensional printer.

There are deflecting flaps (12) located at the bottom of the hinged stabilizing flap (6) and the radial struts (9) in order to move the helicopter forward, backward, right and left. In the preferred embodiment, there are four deflecting flaps (12) where two interconnected deflecting flaps (12) are connected to one servo motor (11) and the other two are connected to another servo motor (11). Result of the experiments carried out has revealed that the use of four deflecting flaps (12) provides optimum maneuverability.

The servo motors (11) which move the deflecting flaps (12) are located at the point where the deflecting flaps (12) are connected to the side support rods (5). A servo motor housing (19) is used to integrate the servo motors (11) to the side support rods (5). The views of the aforementioned servo motors (11) and the servo motor housings (19) connecting them to the side support rods (5) are provided in the FIG. 25 in details. The said servo motor housings (19) are preferably manufactured from a plastic material with a three-dimensional printer.

The deflecting flap rods (13) are used in order to attach these deflecting flaps (12) to the side support rods (5). The deflecting flap rods (13) are preferably made of carbon. Rod clamping couplers (14) are used in order to fix the deflecting flaps (12) to the side support rods (5). The rod clamping couplers (14) of which the detailed view is provided in the FIG. 16 are preferably manufactured from a plastic material with a three-dimensional printer.

The deflecting flaps (12) extend on the deflecting flap rods (13) which are connected to the side support rods (5) by extending from the central zone. The deflecting flaps (12) are in the form of a planar quadrangle as demonstrated in the FIG. 14. They are preferably rectangular in shape and the aforementioned deflecting flap rods (13) extend from one short edge to the other short edge. A part of these deflecting flap rods (13) extending from one short edge to the other short edge are terminated by connecting them to the side support rods (5) from one end. The other part of them is connected to the servo motors (11) from their ends. The deflecting flap rods (13) are made of carbon in the preferred embodiment.

Deflecting flap holders (16) are used in order to fix the deflecting flaps (12) to the deflecting flap rods (13). In one embodiment, there are deflecting flap holders (16) which are located at the deflecting flaps (12) short edges which are close to the center and/or to the side support rods (5) and wrapping and holding these short edges completely or, at least, partially. Deflecting flap holders (16) are shown in the FIG. 18 in a detailed manner. Their locations are demonstrated in the FIG. 1. Deflecting flap holders (16) are preferably manufactured from a plastic material using a three-dimensional printer. Eight pieces of deflecting flap holders (16) are used totally where each hinged deflecting flap (12) has two of them.

In one embodiment, a sleeve bushing (18) is placed on the grooves opened in the end ring (1) in order to effectively utilize the lifting force generated by the two-blade propeller (4) and enhance the overall strength of the system. The sleeve bushing (18) made of a polycarbonate material. It is preferably transparent polycarbonate. The sleeve bushing (18) maximizes the thrust force by preventing the air flowing downward inside the system from quitting the system.

An electronic speed controller (20) is provided in the system in order to drive the brushless electric motor (3) used in the helicopter described above. At the same time, there is a battery (21) in the system. The abovementioned electronic speed controller (20) is demonstrated in the FIG. 22 and the battery (21) in the FIG. 23. In the preferred embodiment, these two components are positioned on the upper mount brace (2) included in the system and their locations in the rotor system are demonstrated in the FIG. 27. All the energy required for the system is provided by the battery (21). No fuel is used.

An embodiment according to the principles of the invention described above with the different embodiments, together with details, is as follows:

In the invention, two 4 mm thick aluminum composite end rings (1) were used on the top and at the bottom to form the main body of the helicopter. A 40×60 mm aluminum upper mount brace (2) was used in order to fix the 1.8 kW brushless electric motor (3) to the center. Two-bladed propeller (4) was used in order to obtain the required lift in the helicopter. Eight pieces of 10 mm diameter aluminum side support rods (5) are used to fix the lower end ring (1) to the upper end ring (1). Four hinged stabilizing flaps (6) are used in order to provide stability and rotation of the helicopter on its own axis. Hinged stabilizing flap rods (7) made of carbon are used to fasten these hinged stabilizing flaps (6) to the side support rods (5) and the central hub (8). The central hub (8) manufactured from a plastic material using three-dimensional printer is used to fix the servo motor (11) and the bevel gear (22) which position the hinged stabilizing flaps (6). A 3 mm thick, 40 mm wide aluminum radial strut (9) was used to center and secure the central hub (8). Four pieces of radial strut clamping couplers (10) with grooves, which are manufactured from a plastic material using three-dimensional printer are used to secure the radial struts (9) to the side support rods (5). Three servo motors (11) are used in order to actuate the hinged stabilizing flaps (6) and the deflecting flaps (12). A total of four deflecting flaps (12), where two of them are connected to one servo motor (11) and the other two are connected to another servo motor (11), are employed in order to allow the helicopter to turn right and left and move forward and backward. Deflecting flap rods (13) made of carbon are used to attach these deflecting flaps (12) to the side support rods (5). Two carbon rod clamping couplers (14) with two holes drilled, which are manufactured from the plastic material through a three-dimensional printer are used in order to fix the deflecting flaps (12) to the side support rods (5). A total of twelve, being three hinged stabilizing flap holders (15) for each hinged stabilizing flap (6), which are manufactured from a plastic material using a three dimensional printer, are used in order to fix the hinged stabilizing flaps (6) to the carbon hinged stabilizing flap rods (7). A total of eight, being two deflecting flap holders (16) for each hinged deflecting flap (12), which are manufactured from a plastic material using a three dimensional printer, are used in order to fix the deflecting flaps (12) to the carbon deflecting flap rods (13). A central hub cap (17) provided with four holes on it and manufactured from a plastic material using a three dimensional printer, is used in order for the carbon hinged stabilizing flap rods (7) to be fully seated on the bevel gear (22) and be attached to the central hub (8). A 1.5 mm thick polycarbonate transparent sleeve bushing (18) placed on the grooves opened in the end ring (1) is used in order to effectively utilize the lift generated by the two-blade propeller (4) and enhance the overall strength of the system. A servo motor housing (19) manufactured from a plastic material using a three dimensional printer, is used to fix the servo motors (11) employed for the deflecting flaps (12) to the side support rods (5). A one hundred ampere electronic speed controller (20) and five-cell 18.5 volt lithium polymer battery (21) are used in order to drive the brushless electric motor (3) employed in the helicopter.

In summary, the invention of which the details and different embodiments have been explained above is based on the principle that a single propeller (4) is used even though there is no tail mechanism and the torque generated by this propeller (4) is provided by means of the hinged stabilizing flaps (6).

The operation of the described rotor system is briefly as follows:

Helicopter is kept in balance by the hinged stabilizing flaps (6) which compensate for the torque generated by the propeller (4) when the brushless electric motor (3) installed to the upper mount brace (2) starts running in the system which is secured between two end rings (1) by supporting the side support rods (5). The rotation of helicopter around its axis is also achieved through such hinged stabilizing flaps (6), by positioning the bevel gear (22) operated by the servo motor (11) integrated to the central hub (8). The deflecting flaps (12) located at the bottom of the helicopter can be actuated by the signals communicated to the servo motor (11) and in this way, it will be possible to move helicopter forward, backward, right and left.

Passenger or cargo cabin is positioned around the rotor system described in the subject system of the application filed. Such positioning must be designed in such a way that the top and bottom sides of the rotor system will be left empty. As a result, additional elements required to be transported by the rotor system such as a cabin or camera need to occupy some or all of the outer perimeter of the rotor system in such a way that the flight dynamics of the rotor system will not be disturbed.

### EXPLANATIONS OF THE FIGURES

FIG. 1: General view of the rotor construction

FIG. 2: General view of the ring

FIG. 3: Detailed view of the ring

FIG. 4: Detailed view of the upper mount brace

FIG. 5: Detailed view of the brushless electric motor

FIG. 6: Detailed view of the two-bladed propeller

FIG. 7: Detailed view of the side support rods

FIG. 8: Detailed view of the hinged stabilizing flaps

FIG. 9: Detailed view of the hinged stabilizing flap rods

FIG. 10: Detailed view of the central hub

FIG. 11: Detailed view of the radial strut

FIG. 12: Detailed view of the radial strut clamping coupler

FIG. 13: Detailed view of the servo motor

FIG. 14: Detailed view of the deflecting flaps

FIG. 15: Detailed view of the deflecting flap rods

FIG. 16: Detailed view of the rod clamping couplers

FIG. 17: Detailed view of the hinged stabilizing flap holders

FIG. 18: Detailed view of the hinged deflecting flap holders

FIG. 19: Detailed view of the central hub cap

FIG. 20: Detailed view of the sleeve bushing

FIG. 21: Detailed view of the servo motor housing

FIG. 22: Detailed view of the electronic speed controller

FIG. 23: Detailed view of the battery

FIG. 24: Diagram showing the position of the bevel gear in the rotor system assembly

FIG. 25: Diagram showing the positions of servo motor, central hub cap, servo motor housing

in the rotor system assembly

FIG. 26: View of the hinged stabilizing flap holders in the rotor system assembly

FIG. 27: View of the battery and the electronic speed controller in the rotor system assembly

FIG. 28: Diagram showing position of the servo motors operating the deflecting flaps in the rotor

system assembly

FIG. 29: Diagram showing position of the servo motor operating the hinged stabilizing flaps in the rotor system assembly

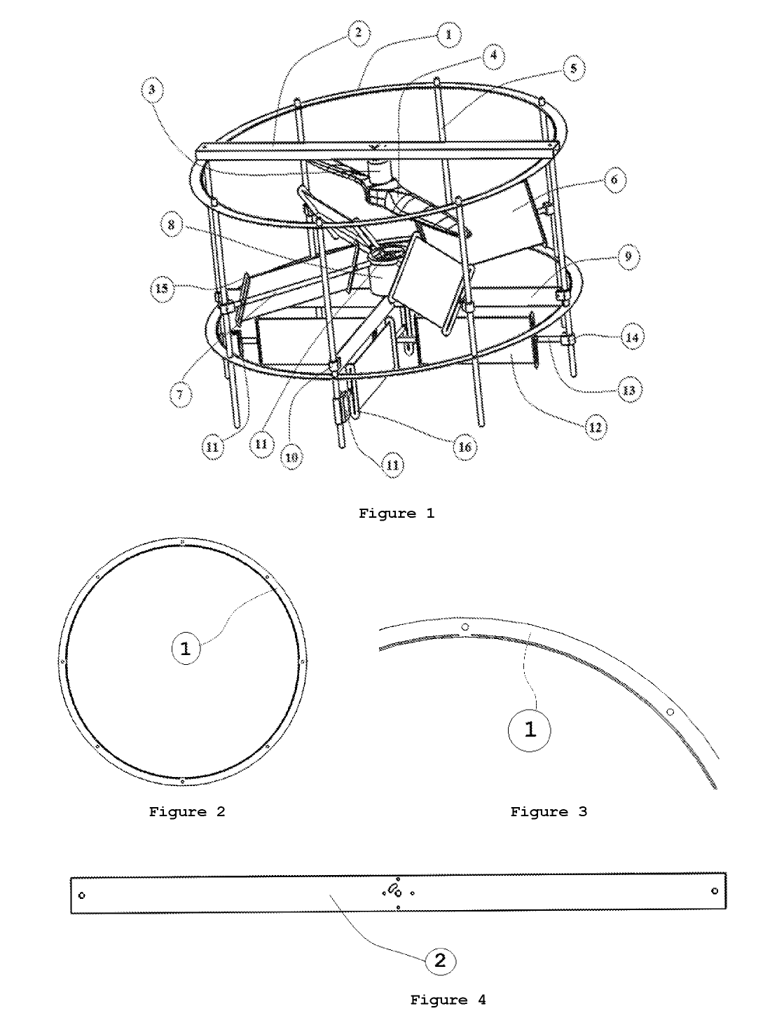

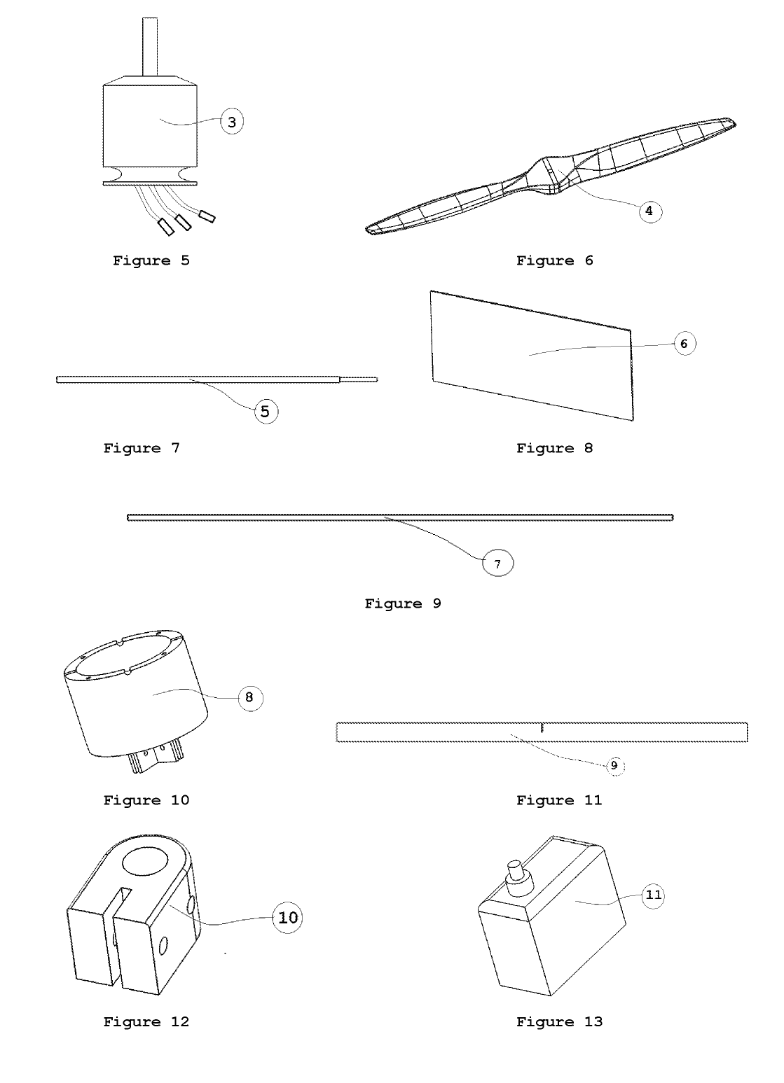

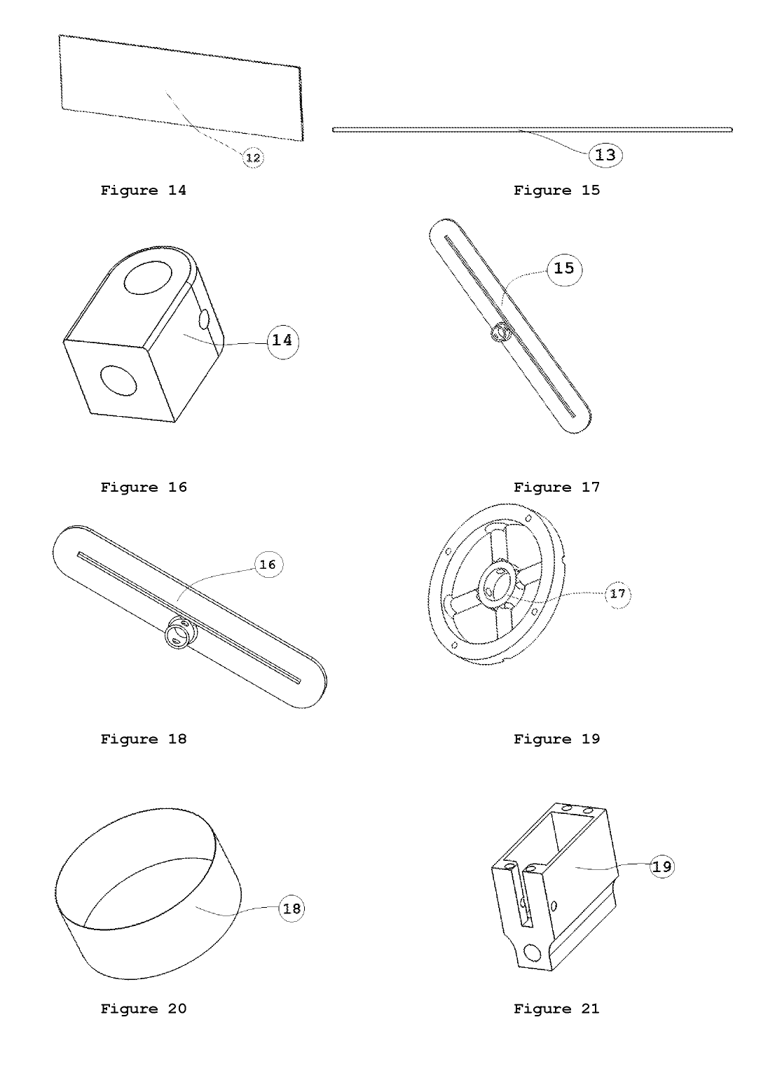

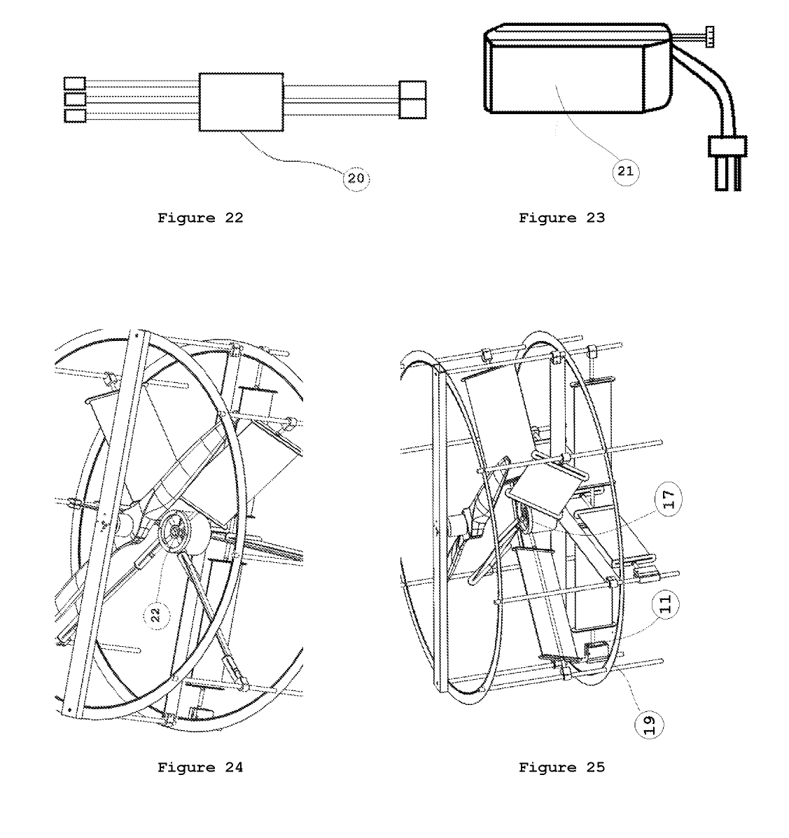

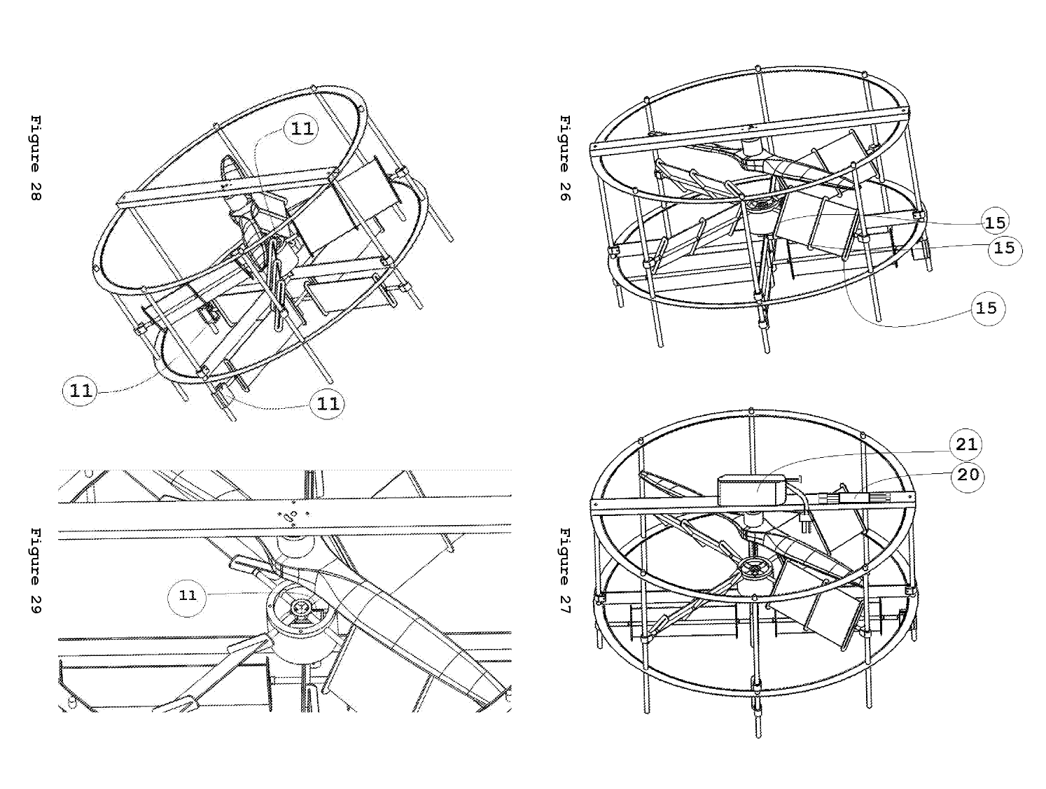

### REFERENCES

1—End ring
2—Upper mount brace
3—Electric motor
4—Propeller
5—Side support rods
6—Hinged stabilizing flaps
7—Hinged stabilizing flap rod
8—Central hub
9—Radial strut
10—Radial strut clamping coupler
11—Servo motor
12—Deflecting flaps
13—Deflecting flap rods
14—Rod clamping coupler
15—Hinged stabilizing flap holders
16—Deflecting flap holders
17—Central hub cap
18—Sleeve bushing
19—Servo motor housing
20—Electronic speed controller
21—Battery
22—Bevel gear

1. A rotor system for a rotor air vehicle, comprising an outer frame which constitutes the main body of the rotor system, in a structure suitable to accommodate moving and fixed components in its inner zone and allow the rotation of a propeller (4), and offers at least two mutual openings through which the air will enter the system and leave the system, characterized in comprising,
a propeller (4) which is located inside the aforementioned outer frame and centrally connected to the ceiling of the outer frame in such a way its front face will be pointing at the inner zone and function as the main rotor, and a motor to generate the required torque to run the said propeller (4),
hinged stabilizing flaps (6) which are positioned against the front face of the said propeller (4) and have planar plates extending in the radial direction towards the outer frame from a central hub (8) facing the center of the propeller (4) and fully or nearly perpendicular to the centerline of the propeller (4) and meet the torque requirements by which the said plates move around the axes parallel to the rotation plane of the propeller (4) by adjusting their angles with respect to the rotation plane,
a motor to actuate the hinged stabilizing flaps (6), and
deflecting flaps (12) which are located at the other side of the hinged stabilizing flaps (6), have and are constituted from the planar plates fully or nearly perpendicular to the centerline of the propeller (4) and provide the air vehicle to move forward, backward, right and left by rotating the aforementioned plates in the desired direction by means of motors.

2. The rotor system according to claim 1, wherein the outer frame comprises;
end rings (1) which are circular or considerably circular and form a cylindrical inner zone on a large scale by positioning them fully or nearly parallel to each other in such a way that their centers are lined up on the same vertical axis,
side support rods (5) which are suitable to fix the positions of the end rings (1) with respect to each other, line up around the end ring (1) perimeter extending from one circle arc to another, connecting the end rings (1) with each other and also forming a surface to install the components located inside the system.

3. The rotor system according to claim 2, wherein the side support rods (5) are made of aluminum.

4. The rotor system according to claim 1, wherein it comprises a servo motor (11) and bevel gears (22) in the central hub (8), in order to provide positioning by moving the hinged stabilizing flaps (6).

5. The rotor system according to the claim 2, wherein the outer frame comprises an upper mount brace (2) holding the propeller (4) and the motor which runs the propeller (4) and passing through the centers of the end ring (1) which is located at the top.

6. The rotor system according to claim 2, wherein it comprises side support rods (5) which connects the hinged stabilizing flaps (6) to the outer frame.

7. The rotor system according to claim 1, wherein it comprises hinged stabilizing flaps (6) extended on the hinged stabilizing flap rods (7) which are connected to the side support rods (5) by extending from the central hub (8).

8. The rotor system according to claim 1, wherein the hinged stabilizing flaps (6) are in the form of a planar quadrangle and preferably in rectangular form.

9. The rotor system according to claim 8, wherein it comprises hinged stabilizing rods (7) which are extended between the short edges of the hinged stabilizing flaps (6) in rectangular form and are terminated by connecting to the central hub (8) from one end and to the side support rods (5) from the other end.

10. The rotor system according to claim 9, wherein the hinged stabilizing flap rods (7) are made of carbon.

11. The rotor system according to claim 1, wherein it comprises hinged stabilizing flap holders (15) which are located at the edges of the hinged stabilizing flaps (6) close to the center and/or to the side support rods (5) and wrapping and holding these edges completely or, at least, partially.

12. The rotor system according to claim 11, wherein each hinged stabilizing flap (6) comprises three hinged stabilizing flap holders (15) at the head, middle and end sections of hinged stabilizing flaps (6).

13. The rotor system according to claim 4, wherein the hinged stabilizing flap rods (7) are connected to the bevel gears (22) in the central hub (8) so as to transmit the movement from the servo motor (11) to the bevel gears (22), from the bevel gears (22) to the hinged stabilizing flap rods (7) and, in this way, to the hinged stabilizing flaps (6).

14. The rotor system according to claim 13, wherein it comprises a central hub cap (17) with four holes provided on it to ensure that the hinged stabilizing flap rods (7) are fully seated on the bevel gear (22) and are fastened to the central hub (8).

15. The rotor system according to claim 14, wherein it comprises the radial struts (9) which center the central hub (8) and keep it fixed so as to be positioned on the central axes of the end rings (1), and also extend to the side support rods (5) from the central hub (8) and connect to the side support rods (5) by means of the radial strut clamping coupler (10).

16. The rotor system according to claim 1, wherein the hinged deflecting flaps (12) are connected to the outer frame from the side support rods (5) and it comprises servo motors (11) to actuate the hinged deflecting flaps (12), which are located at the section where the hinged deflecting flaps (12) are connected with the side support rods (5).

17. The rotor system according to claim 16, wherein it comprises four deflecting flaps (12) where two interconnected deflecting flaps (12) are connected to one servo motor (11) and the other two are connected to another servo motor (11).

18. The rotor system according to claim 16, wherein it comprises a servo motor housing (19) to fix the servo motors (11) to the side support rods (5).

19. The rotor system according to claim 16, wherein the deflecting flaps (12) are extended on the deflecting flap rods (13) which are connected to the side support rods (5) by extending from the central zone.

20. The rotor system according to claim 19, wherein it comprises rod clamping couplers (14) in order to fix the deflecting flaps (12) to the side support rods (5) with the deflecting flap rods (13).

21. The rotor system according to claim 19, wherein the deflecting flaps (12) are in the form of a planar quadrangle, preferably rectangular in shape.

22. The rotor system according to claim 21, wherein the aforementioned deflecting flap rods (13) are extended from one short edge to the other short edge and a part of them are terminated by connecting them to the side support rods (5) from one end, and the other part of them is connected to the servo motors (11) from their ends.

23. The rotor system according to claim 21, wherein, it comprises deflecting flap holders (16) located at the deflecting flaps (12) short edges which are close to the center and/or to the side support rods (5) and holding by wrapping these short edges completely or, at least partially, in order to fix the deflecting flaps (12) to the deflecting flap rods (13).

24. The rotor system according to claim 2, wherein it comprises grooves opened in the end ring (1) in order to effectively utilize the lift generated by the two-blade propeller (4) and enhance the overall strength of the system and a sleeve bushing (18), preferably made of a polycarbonate material, which is placed on these grooves and maximizes the thrust force by preventing the air flowing downward from quitting the system.

25. The rotor system according to claim 1, wherein the motor that drives the propeller (4) is a brushless electric motor (3).

26. The rotor system according to claim 25, wherein it comprises an electronic speed controller (20) and a battery (21) in the system in order to run the brushless electric motor (3).

27. The rotor system according to claim 5, wherein the battery (21) and the electronic speed controller (20) are located on the upper mount brace (2) available in the system.

28. An air vehicle comprising a rotor system according to claim 1.

29. The air vehicle according to claim 28, wherein it comprises a cabin, especially a passenger cabin or a cargo cabin, surrounding all or a part suitable for assuring stability, of the circumferential outer periphery of the outer frame forming a cylindrical inner zone, and leaving the top and bottom of the rotor system open.

30. A rotor system for a rotor air vehicle characterized in comprising,
two aluminum composite end rings (1) located at the top and bottom to form the main body of the rotor system,
a brushless electric motor (3) and an aluminum upper mount brace (2) for fixing the said electric motor (3) to the center,
a propeller (4), preferably a two-blade propeller (4), for obtaining a lifting force,
more than one, preferably eight aluminum side support rods (5), in order to fix the lower end ring (1) to the upper end ring (1),
four hinged stabilizing flaps (6) to provide the air vehicle with stability and rotation around its own axis,
carbon hinged stabilizing flap rods (7) for attaching these hinged stabilizing flaps (6) to the side support rods (5) and the central hub (8)
a servo motor (11) and the bevel gears (22) which position the hinged stabilizing flaps (6)
a plastic central hub (8) in order to fix the servo motor (11) and the bevel gears (22) which position the hinged stabilizing flaps (6),
aluminum radial strut (9) for centering and fixing the central hub (8),
plastic radial strut clamping couplers (10) for fixing the radial struts (9) to the side support rods (5)
three servo motors (11) dedicated to actuate the hinged stabilizing flaps (6) and the deflecting flaps (12)
a total of four deflecting flaps (12), where two of them are connected to one servo motor (11) and the other two are connected to another servo motor (11), which are employed in order to allow the helicopter to turn right and left and move forward and backward,
deflecting flap rods (13) made of carbon are used to attach these deflecting flaps (12) to the side support rods (5),
carbon rod clamping couplers (14) made of plastic to fix the deflecting flaps (12) to the side support rods (5)
hinged stabilizing flap holders (15) made of plastic material in order to fix the hinged stabilizing flaps (6) to the hinged stabilizing flap rods (7) made of carbon,
deflecting flap holders (16) made of plastic material in order to fix the deflecting flaps (12) to the carbon deflecting flap rods (13),
a polycarbonate transparent sleeve bushing (18) placed on the grooves opened in the end ring (1) in order to effectively utilize the lifting force generated by the two-blade propeller (4) and enhance the overall strength of the system,
a servo motor housing (19) to fix the servo motors (11), employed for the deflecting flaps (12), to the side support rods (5), and
an electronic speed controller (20) and a lithium polymer battery (21) in order to drive the brushless electric motor (3) used in the helicopter.

31. An air vehicle comprising a rotor system according to the claim 30.

32. The air vehicle according to claim 31, wherein it comprises a cabin, especially a passenger cabin or a cargo cabin, surrounding all or a part suitable for assuring stability, of the circumferential outer periphery of the outer frame forming a cylindrical inner zone, and leaving the top and bottom of the rotor system open.

33. The rotor system according to claim 2, wherein it comprises hinged stabilizing flaps (6) extended on the hinged stabilizing flap rods (7) which are connected to the side support rods (5) by extending from the central hub (8).

34. The rotor system according to claim 9, wherein the hinged stabilizing flap rods (7) are connected to the bevel gears (22) in the central hub (8) so as to transmit the movement from the servo motor (11) to the bevel gears (22), from the bevel gears (22) to the hinged stabilizing flap rods (7) and, in this way, to the hinged stabilizing flaps (6).

35. The rotor system according to claim 26, wherein the battery (21) and the electronic speed controller (20) are located on the upper mount brace (2) available in the system.

36. An air vehicle comprising a rotor system according to claim 2.
